(19) United States
(12) Patent Application Publication
(10) Pub. No.: US 2020/0252732 A1
(43) Pub. Date: Aug. 6, 2020

(54) PERSONALIZED EARPHONE FOR PEOPLE WITH AUDITORY ABNORMALITY

(71) Applicant: Innovation Sound Technology Co., Ltd, Shenzhen, Guangdong (CN)

(72) Inventors: Shun Ming Yuen, Shenzhen, Guangdong (CN); Wai Yin Mung, Shenzhen, Guangdong (CN); Ka Ming Wu, Shenzhen, Guangdong (CN)

(21) Appl. No.: 16/092,443

(22) PCT Filed: Aug. 17, 2018
(86) PCT No.: PCT/CN2018/101195

§ 371 Date: Oct. 9, 2018

(30) Foreign Application Priority Data
Feb. 12, 2018 (CN) 201820253473.6

(51) Int. Cl. H04R 25/00

(52) U.S. Cl. CPC H04R 25/505; H04R 2460/01; H04R 25/554

(57) ABSTRACT

A personalized earphone for people with auditory abnormality, includes a microphone, a preamplifier, an analogue-to-digital (A/D) converter, a Bluetooth wireless circuit, a Digital Signal Processing (DSP) module, a digital-to-analogue (D/A) converter, a post-amplifier and a loudspeaker. The microphone is arranged to pick up an ambient noise and deliver information about the ambient noise to the preamplifier, the preamplifier is arranged to convert the ambient noise to a digital signal and input the digital signal to the DSP module. The DSP module is arranged to internally generate a noise-reduction signal that is converted to an original noise, and convert the noise-reduction signal to an analogue signal that is amplified by the post-amplifier and delivered to the loudspeaker. The DSP module is connected with the Bluetooth wireless circuit.

### TECHNICAL FIELD

The disclosure relates to the technical field of articles for daily use, and in particular to a personalized earphone for people with auditory abnormality.

### BACKGROUND

Statistics on the global prevalence rate of Autism Spectrum Disorders (ASD) shows that one among one hundred and sixty children suffers from the ASD (WHO, 2017). The US has a steadily increasing ASD prevalence rate. Mainstream schools in Hong Kong also have an increase rate of 20% in 2010. Researches show that children with ASD have sensory abnormality. 70% percent of children with ASD are found to have relatively high sensitivity to auditory stimulation. Statistics shows that it is necessary to stipulate strategies or guidelines for these children, or even support them to deal with such a challenge.

Children with ASD are found to use self-treatment strategies such as covering of their ears, crying or even self harming. These actions affect their daily life, social communications and study. Improving ambient sounds in an acoustic manner is important to strengthen treatment to ASD and for children. Earmuffs or earplugs may produce positive influence on problems related to responsiveness of children with ASD to auditory stimulation. Noise-canceling (NC) earphones are potential solutions for children with ASD. However, children with ASD have different sensitivities to auditory stimulation. For preschool or primary school children with ASD, adjustment of their sensitivities to auditory stimulation strengthens their study. This facilitates their future development under auditory environments. It is of great importance to develop personalized noise-canceling systems for children with ASD.

### SUMMARY

The embodiments of the disclosure are intended to overcome the disadvantages of existing techniques. The personalized earphone for people with auditory abnormality provided according to embodiments of the disclosure can be adjusted using Bluetooth technique to serve as a general heating aid. It can serve as a Bluetooth earphone to implement the hearing aid function during a phone call and for listening to music. The noise-canceling techniques used include DSP noise-canceling technique and passive noise-canceling technique for auditory frequency responses of different people and for a specific earphone mechanical structure. The sensitivity of each patent with ASD within a specific frequency range can be estimated through Bluetooth technique. Thus, the problem in the Background section can be solved.

In order to solve the above technical problem, technical solutions are provided as follows.

There is provided a personalized earphone for people with auditory abnormality, including a microphone, a preamplifier, an A/D converter, a Bluetooth wireless circuit, a DSP module, a D/A converter, a post-amplifier and a loudspeaker. The microphone is arranged to pick up an ambient noise and deliver information about the ambient noise to the preamplifier, the preamplifier is arranged to convert the ambient noise to a digital signal and input the digital signal to the DSP module, and the DSP module is arranged to internally generate a noise-reduction signal that is converted to an original noise, and convert the noise-reduction signal to an analogue signal that is amplified by the post-amplifier and delivered to the loudspeaker, the DSP module being connected with the Bluetooth wireless circuit.

In an embodiment, the microphone is arranged to pick up the ambient noise and deliver the ambient noise to the preamplifier, and the preamplifier is arranged to generate a waveform inverted from a waveform of the ambient noise and deliver the generated inverted waveform back to the microphone.

In an embodiment, the Bluetooth wireless circuit is tuned with a computer or a mobile phone.

Embodiments of the disclosure have the following beneficial effects. The personalized earphone for people with auditory abnormality according to embodiments of the disclosure can be adjusted using Bluetooth technique to serve as a general heating aid. It can serve as a Bluetooth earphone to implement the hearing aid function during a phone call and for listening to music. The noise-canceling techniques used include DSP noise-canceling technique and passive noise-canceling technique for auditory frequency responses of different people and for a specific earphone mechanical structure. The sensitivity of each patent with ASD within a specific frequency range can be estimated through Bluetooth technique.

### BRIEF DESCRIPTION OF THE DRAWINGS

The accompanying drawings, as a part of the description, are used to explain embodiments of the disclosure, and not intended to limit the scope of protection. In the drawing:

FIG. 1 is a schematic diagram showing the operation principle of a personalized earphone for people with auditory abnormality according to an embodiment of the disclosure.

Where 1 denotes a microphone, 2 denotes a preamplifier, 3 denotes an A/D converter, 4 denotes a Bluetooth wireless circuit, 5 denotes a DSP module, 6 denotes a D/A converter, 7 denotes a post-amplifier and 8 denotes a loudspeaker.

### DETAILED DESCRIPTION

Preferred embodiments of the disclosure will be elaborated below with reference to accompanying drawings, and it should be appreciated that preferred embodiments described below are only used to describe and explain the disclosure instead of limiting it.

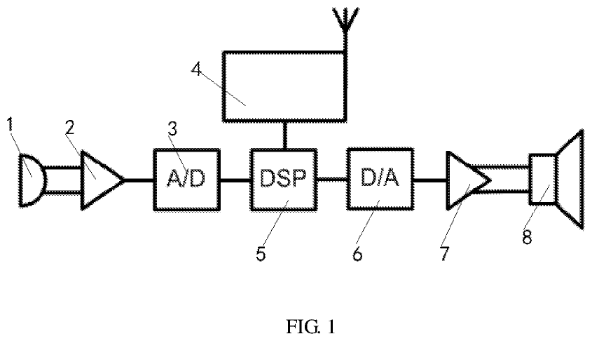

As shown in FIG. 1, a personalized earphone for people with auditory abnormality according to an embodiment of the disclosure includes a microphone 1, a preamplifier 2, an A/D converter 3, a Bluetooth wireless circuit 4, a DSP module 5, a D/A converter 6, a post-amplifier 7 and a loudspeaker 8, wherein the microphone 1 is arranged to pick up an ambient noise and deliver information about the ambient noise to the preamplifier 2, the preamplifier 2 is arranged to convert the ambient noise to a digital signal and input the digital signal to the DSP module 5, and the DSP module 5 is arranged to internally generate a noise-reduction signal that is converted to an original noise, and convert the noise-reduction signal to an analogue signal that is amplified by the post-amplifier 7 and delivered to the loudspeaker 8. The DSP module 5 is connected with the Bluetooth wireless circuit 4. The microphone 1 picks up the ambient noise and delivers the ambient noise to the preamplifier 2, which generates a waveform inverted from a waveform of the ambient noise and delivers the generated inverted waveform back to the microphone 1. The Bluetooth wireless circuit 4 is tuned with a computer or a mobile phone.

It is to be noted that the personalized earphone for people with auditory abnormality according to embodiments of the disclosure can be adjusted, in operation, using Bluetooth technique to serve as a general heating aid. It can serve as a Bluetooth earphone to implement the hearing aid function during a phone call and for listening to music. The noise-canceling techniques used include DSP noise-canceling technique and passive noise-canceling technique for auditory frequency responses of different people and for a specific earphone mechanical structure. The sensitivity of each patent with ASD within a specific frequency range can be estimated through Bluetooth technique.

It is to be noted that what described above are merely preferred embodiments of the disclosure and are not intended to limit the disclosure. Although the disclosure is elaborated with reference to the above embodiments, those skilled in the art may modify the technical solutions as disclosed above, or make replacements of part of technical features of the technical solutions. All modifications, replacements and improvements made within the spirit and principles of the disclosure should be included within the scope of protection of the disclosure.

1. A personalized earphone for people with auditory abnormality, comprising a microphone (1), a preamplifier (2), an analogue-to-digital (A/D) converter (3), a Bluetooth wireless circuit (4), a Digital Signal Processing (DSP) module (5), a digital-to-analogue (D/A) converter (6), a post-amplifier (7) and a loudspeaker (8), wherein the microphone (1) is arranged to pick up an ambient noise and deliver information about the ambient noise to the preamplifier (2), the preamplifier (2) is arranged to convert the ambient noise to a digital signal and input the digital signal to the DSP module (5), and the DSP module (5) is arranged to internally generate a noise-reduction signal that is converted to an original noise, and convert the noise-reduction signal to an analogue signal that is amplified by the post-amplifier (7) and delivered to the loudspeaker (8), the DSP module (5) being connected with the Bluetooth wireless circuit (4).

2. The personalized earphone for people with auditory abnormality according to claim 1, wherein the microphone (1) is arranged to pick up the ambient noise and deliver the ambient noise to the preamplifier (2), and the preamplifier (2) is arranged to generate a waveform inverted from a waveform of the ambient noise and deliver the generated inverted waveform back to the microphone (1).

3. The personalized earphone for people with auditory abnormality according to claim 1, wherein the Bluetooth wireless circuit (4) is tuned with a computer or a mobile phone.
